(19) United States
(12) Patent Application Publication
(10) Pub. No.: US 2025/0369652 A1
(43) Pub. Date: Dec. 4, 2025

(54) ELECTRIC TANKLESS WATER HEATER SCALE DETECTION

(71) Applicant: A. O. Smith Corporation, Milwaukee, WI (US)

(72) Inventors: Chad T. Thompson, Talbott, TN (US); Jason Rodifer, Jonesborough, TN (US); Peyton Lawyer, White House, TN (US); Devin Israelson, Roswell, NM (US); Michael Thomas, Murfreesboro, TN (US)

(21) Appl. No.: 18/733,598

(22) Filed: Jun. 4, 2024

(51) Int. Cl. F24H 15/288; F24H 1/10; F24H 15/128; F24H 15/395; G01K 1/02; G01K 3/00; G01K 3/04; G01K 3/08

(52) U.S. Cl. CPC F24H 15/288; F24H 1/101; F24H 15/128; F24H 15/395; G01K 1/026; G01K 3/005; G01K 3/04; G01K 3/08

(57) ABSTRACT

A water heating system includes a first heating chamber arranged in parallel with a second heating chamber; a first temperature sensor positioned to sense a first temperature in the first heating chamber; a second temperature sensor positioned to sense a second temperature in the second heating chamber; and a controller configured to: determine a first temperature value based on a first sensor signal from the first temperature sensor, determine a second temperature value based on a second sensor signal from the second temperature sensor, compute a differential between the first temperature value and the second temperature value, determine that scale buildup is indicated in response to the differential exceeding a first threshold, and initiate a corrective action in response to determining that scale buildup is indicated.

### FIELD

The present disclosure relates to water heating systems and, more particularly, to control systems for electric tankless water heating systems.

### SUMMARY

Electric tankless water heaters use electric heating elements to provide on-demand heating of water passing through the unit (unlike traditional water heaters, which store heated water in a tank). Since such water heaters do not require a storage tank, they may be considered “tankless.” The on-demand heating action of electric tankless water heaters allows them to offer various technical benefits. For example, since electric tankless water heaters heat water on demand, they do not store hot water and continuously reheat stored water like traditional water heaters. Thus, this on-demand heating may reduce energy consumption, as the electric tankless water heater does not need to add heat to water stored in the tank (for example, in response to heat loss to the external ambient environment). Furthermore, since electric tankless water heaters do not require a storage tank, they can have a compact form factor, allowing them to be installed in smaller spaces and/or mounted on a wall, which frees up floor space.

Some examples of electric tankless water heaters include one or more electrical heating elements disposed within one or more heating chambers. Water may flow into and be heated within each heating chamber. In various implementations, the chamber is sized to minimize the distance between the heating elements and the walls of the heating chambers. Minimizing the distance between the heating elements and the walls of the heating chambers may allow for quicker heating of the water as it passes through each chamber, reducing the delay between an initial demand draw and an actual delivery of the hot water. Furthermore, minimizing the distance between the heating elements and the walls of the heating chambers reduces the overall size of the heating chambers, which may in turn minimize an amount of residual water remaining in the chambers when the water flow stops and allow the electric tankless water heater to have a more compact form factor.

However, in many regions, the water available to the water heater may contain dissolved minerals such as calcium carbonate and magnesium carbonate. When the heating elements heat water containing relatively high concentrations of mineral ions (such as calcium and/or magnesium ions), the minerals may precipitate out of solution from the water. Since mineral solubility decreases more rapidly at higher temperatures and the water proximate to the surfaces of the heating elements tends to be at the highest temperatures within each heating chamber, the minerals tend to precipitate out of the water and deposit as scale on the surfaces of the heating elements. Such scale buildup may reduce the heat transfer efficiency from the heating elements to the water and/or reduce the space between the heating elements' surfaces and the heating chambers' walls, which can restrict water flow and decrease the overall operating efficiency of the water heater.

Such technical problems may be mitigated by proactively removing the scale buildup (for example, through chemical treatment and/or mechanical cleaning). However, detecting scale buildup on the heating elements of electric tankless water heaters can be challenging. For example, the heating elements are often located within the water heater's heating chambers, which may not be readily visible or accessible. Thus, scale buildup may occur out of sight. Furthermore, scale buildup may not cause readily noticeable changes in the water heater's performance to the end user. To address these and other technical problems, systems, apparatuses, methods, and techniques described in this specification detect potential scale buildup on heating elements of electric tankless water heaters and notify the end user, allowing the user to remove the scale buildup proactively.

A water heating system includes a first heating chamber arranged in parallel with a second heating chamber; a first temperature sensor positioned to sense a first temperature in the first heating chamber; a second temperature sensor positioned to sense a second temperature in the second heating chamber; and a controller configured to: determine a first temperature value based on a first sensor signal from the first temperature sensor, determine a second temperature value based on a second sensor signal from the second temperature sensor, compute a differential between the first temperature value and the second temperature value, determine that scale buildup is indicated in response to the differential exceeding a first threshold, and initiate a corrective action in response to determining that scale buildup is indicated.

In other features, the first temperature value represents an average of the first sensor signal taken over time and the second temperature value represents an average of the second sensor signal taken over time. In other features, the controller is further configured to determine a number of times the differential exceeds the threshold and determine that scale buildup is indicated in response to the number of times exceeding a second threshold. In other features, the controller is configured to determine a number of hot water demand draws during which the differential exceeds a second threshold. The corrective action is only initiated when the number of hot water demand draws exceeds the second threshold.

In other features, the controller is further configured to determine a number of hot water demand draws during which the differential exceeds a second threshold. The corrective action is only initiated when the number of hot water demand draws exceeds the second threshold. In other features, the first sensor signal and the second sensor signal are generated during a hot water demand draw. In other features, the controller is configured to determine that scale buildup is indicated in one of the first heating chamber and the second heating chamber.

In other features, the system includes a heating element disposed in the first heating chamber. The controller is further configured to deactivate the heating element in response to the first temperature exceeding a second threshold. In other features, the system includes a user interface. The corrective action comprises displaying on the user interface an indication that scale buildup has occurred. In other features, the system includes a transceiver configured to communicate with a user device. The corrective action comprises transmitting, to the user device via the transceiver, an indication that scale buildup has occurred.

A method for controlling a water heating system includes determining a first temperature value based on a first sensor signal from a first temperature sensor, the first temperature sensor positioned to send a temperature in a first heating chamber, determining a second temperature value based on a second sensor signal from a second temperature sensor, the second temperature sensor positioned to sense a second temperature in a second heating chamber, the second heating chamber being arranged in parallel with the first heating chamber, computing a differential between the first temperature value and the second temperature value, determining that scale buildup is indicated in response to the differential exceeding a first threshold, and initiating a corrective action in response to determining that scale buildup is indicated.

In other features, the first temperature value represents an average of the first sensor signal taken over time and the second temperature value represents an average of the second sensor signal taken over time. In other features, the method includes determining a number of times the differential exceeds the threshold and determining that scale buildup is indicated in response to the number of times exceeding a second threshold. In other features, the method includes determining a number of hot water demand draws during which the differential exceeds a second threshold and determining that scale buildup is indicated in response to the number of hot water demand draws exceeding the second threshold.

In other features, the method includes determining a number of hot water demand draws during which the differential exceeds a second threshold. The corrective action is only initiated when the number of hot water demand draws exceeds the second threshold. In other features, the first sensor signal and the second sensor signal are generated during a hot water demand draw. In other features, the method includes determining that scale buildup is indicated in one of the first heating chamber and the second heating chamber.

In other features, the corrective action comprises deactivating a heating element in response to the first temperature exceeding a second threshold, the heating element being disposed in the first heating chamber. In other features, the corrective action comprises displaying an indication that scale buildup has occurred on a user interface. In other features, the corrective action comprises transmitting an indication that scale buildup has occurred to a user device via a transceiver.

Other examples, embodiments, features, and aspects will become apparent by consideration of the detailed description and accompanying drawings.

### BRIEF DESCRIPTION OF THE DRAWINGS

FIG. 1 is an isometric view of an example electric tankless water heater unit, according to some embodiments.

FIG. 2 is an isometric view of the example water heater unit of FIG. 1 with a cover removed, according to some embodiments.

FIG. 3 is an exploded view of the heating chambers of the example water heater unit of FIGS. 1 and 2, according to some embodiments.

FIG. 4 is an isometric view of an example of the assembled heating chamber of FIGS. 1-3, according to some embodiments.

FIG. 5 is a cross-sectional view of the assembled heating chamber of FIG. 4 taken at section line 4-4, according to some embodiments.

FIG. 6 is a schematic illustration of an example electric tankless water heater unit, according to some embodiments.

FIG. 7 is a schematic illustration of an example electric tankless water heater unit, according to some embodiments.

FIG. 8 is a block diagram showing an example of an interconnected hardware control system for a water heater unit, according to some embodiments.

FIG. 9 is a chart showing temperature readings from a first temperature sensor and a second temperature sensor over a series of three successive water draws, according to some embodiments.

FIG. 10 is a chart showing temperature readings from a first temperature sensor and a second temperature sensor over a series of three successive water draws, according to some embodiments.

FIG. 11 is a flowchart of an example process for controlling a water heater unit, according to some embodiments.

FIG. 12 is a flowchart of an example process for determining whether scale buildup in a water heater unit is indicated, according to some embodiments.

FIG. 13 is a flowchart of an example process for determining whether scale buildup in a water heater unit is indicated, according to some embodiments.

FIG. 14 is a flowchart of an example process for controlling a water heater unit, according to some embodiments.

FIG. 15 is a schematic illustration of an example of an electric tankless water heater unit, according to some embodiments.

In the drawings, reference numbers may be reused to identify similar and/or identical elements.

### DETAILED DESCRIPTION

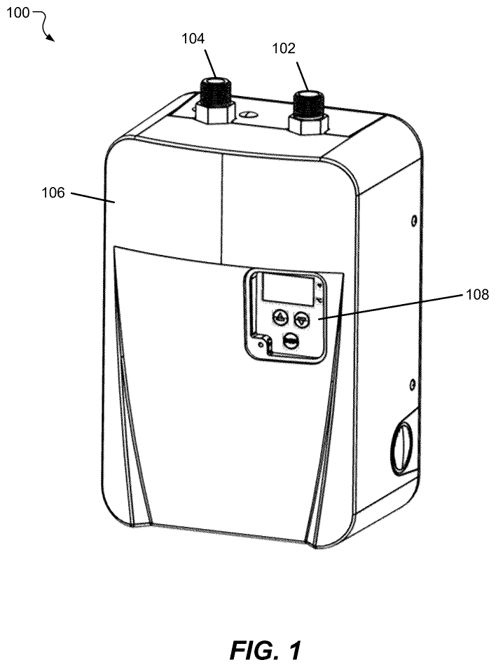

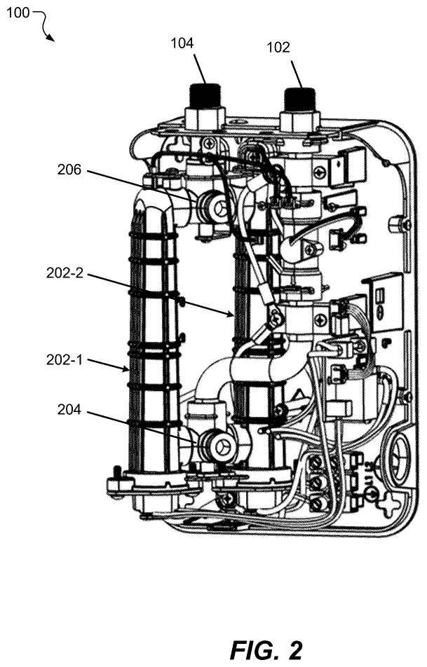

FIG. 1 is an isometric view of an example electric tankless water heater unit 100. In the example of FIG. 1, the water heater unit 100 includes a water inlet 102, a water outlet 104, a cover 106, and a user interface 108. FIG. 2 is an isometric view of the example water heater unit 100 of FIG. 1 with the cover 106 removed. As illustrated in the example of FIG. 2, the water heater unit 100 includes one or more heating chambers 202, such as heating chambers 202-1 and 202-2. Although two heating chambers 202 are shown in the example of FIG. 2, the water heater unit 100 may include any number of heating chambers 202. In various implementations, the water inlet 102, heating chamber 202-1, and heating chamber 202-2 may be connected to a manifold 204. In some examples, the water outlet, heating chamber 202-1, and heating chamber 202-2 may be connected to a manifold 206.

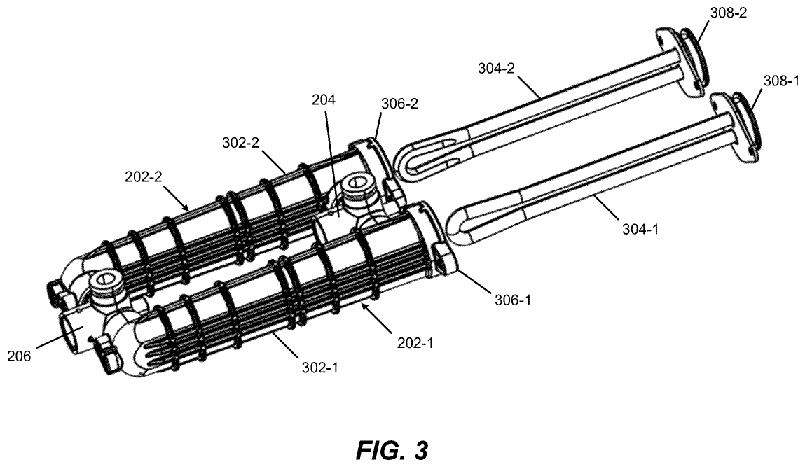

FIG. 3 is an exploded view of the heating chambers 202-1 and 202-2 of the example water heater unit 100 of FIGS. 1 and 2. In various implementations, each heating chamber 202 includes an enclosure 302 and a heating element 304 disposed within the enclosure 302. For example, the heating chamber 202-1 may include an enclosure 302-1 and a heating element 304-1 may be disposed within the enclosure 302-1, and the heating chamber 202-2 may include an enclosure 302-2 and a heating element 304-2 may be disposed within the enclosure 302-2. In various implementations, each enclosure 302 has a mounting flange 306 at an end of the enclosure, and each heating element 304 has a corresponding mounting flange 308 at a corresponding end. For example, enclosure 302-1 may have a mounting flange 306-1, and the corresponding heating element 304-1 may have a corresponding mounting flange 308-1. Similarly, the enclosure 302-2 may have a mounting flange 306-2, and the corresponding heating element 304-2 may have a corresponding mounting flange 308-2.

As illustrated in FIG. 3, the heating chamber 202 may be designed such that the heating element 304 may be removed from the enclosure 302 (for example, to facilitate scale removal from the heating element 304 and/or the enclosure 302). In various implementations, the manifold 204, the manifold 206, and/or the enclosure 302 are formed from a polymer material. For example, the manifold 204, the manifold 206, and/or the enclosure 302 may be injection molded from a thermoplastic material, such as a polyethylene (PE), a polypropylene (PP), a polyvinyl chloride (PVC), a polystyrene (PS), a polyethylene terephthalate (PET), a polycarbonate (PC), an acrylonitrile butadiene styrene (ABS), a polyamide, and/or a polyoxymethylene material. In various implementations, the heating element 304 is a resistive heating element, such as a copper heating element, a stainless steel heating element, a nickel-chromium-iron alloy heating element, a nickel-chromium heating element, a titanium heating element, or a ceramic heating element.

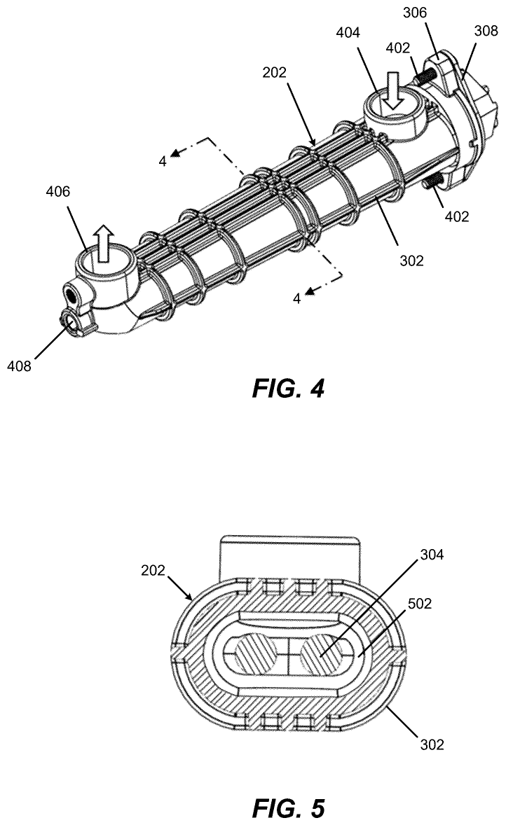

FIG. 4 is an isometric view of an example of the assembled heating chamber 202 of FIGS. 1-3. In the assembled configuration, the mounting flange 306 of enclosure 302 may be fastened to the corresponding mounting flange 308 of the corresponding heating element 304 (for example, with one or more fasteners 402 to form a fluid seal). In various implementations, a sealing element, such as a gasket or an O-ring, may be positioned between and/or compressed by the mating faces of the mounting flange 306 and the mounting flange 308. In some examples, the one or more fasteners 402 include screws, bolts, nuts, washers, rivets, anchors, pins, clips, clamps, tie wraps, and/or cable ties. In various implementations, the enclosure 302 of each heating chamber 202 includes a water inlet 404 and a water outlet 406. The water inlet 404 may be connected to the manifold 204 (for example, with a sealing element positioned between them and secured using a fastener), and the water outlet 406 may be connected to the manifold 206 (for example, with a sealing element positioned between them and secured using a fastener). The enclosure 302 may have a port 408 proximate to the water outlet 406. A temperature sensor (for example, a temperature sensor 604) may be positioned within port 408 to detect a temperature of the water within the heating chamber 202 (for example, near the water outlet 406).

FIG. 5 is a cross-sectional view of the assembled heating chamber 202 of FIG. 4 taken at section line 4-4. As illustrated in the example of FIG. 5, the heating element 304 may be centrally positioned within enclosure 302 in the assembled configuration. The space between the heating element 304 and the enclosure 302 may define a flow passage 502 for water. As water enters and passes through the flow passage 502, the water may be heated by the heating element 304. In various implementations, the flow passage 502 defines a relatively small volume to facilitate the rapid heating of water in response to a demand draw. In various implementations, enclosure 302 is sized to accommodate a flow rate in a range of between about 0.1 and 10 gallons per minute. In some examples, enclosure 302 is sized to accommodate a flow rate of about 0.10, 0.15, 0.20, 0.25, 0.30, 0.35, 0.40, 0.45, or 0.50 gallons per minute.

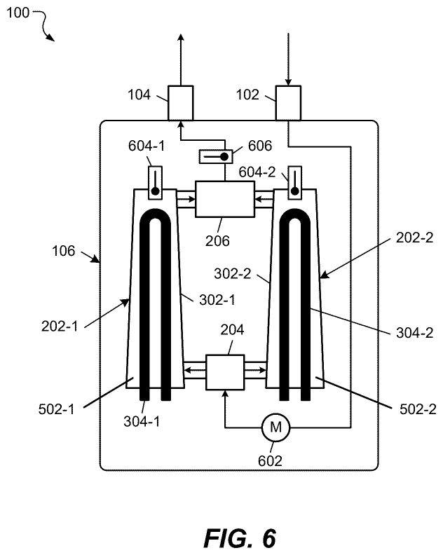

FIG. 6 is a schematic illustration of an example electric tankless water heater unit 100. For example, the water heater unit 100 of FIGS. 1 and 2 may be implemented according to the principles described with reference to FIG. 6. As illustrated in the example of FIG. 6, cold water may enter the water heater unit 100 through the water inlet 102. Within the water heater unit 100, the cold water may flow from the inlet 102 to the manifold 204. The water heater unit 100 may include a flow meter 602, which may be positioned to sense a flow rate of the cold water flowing from the inlet 102 to the manifold 204. In various implementations, the flow meter 602 includes a turbine flow meter, an ultrasonic flow meter, a magnetic flow meter, a positive displacement flow meter, and/or a vortex flow meter. From the manifold 204, the cold water may enter the heating chamber 202-1 via the water inlet 404 of the enclosure 302-1, and may enter the heating chamber 202-2 via the water inlet 404 of the enclosure 302-2.

The cold water may be heated by the heating element 304-1 in the flow passage 502-1 of the heating chamber 202-1, and by heating element 304-2 in the flow passage 502-2 of the heating chamber 202-2. The heated water may exit the heating chamber 202-1 via the water outlet 406 of the enclosure 302-1 and flow into the manifold 206. Similarly, the heated water may exit the heating chamber 202-2 via the water outlet 406 of the enclosure 302-2 and flow into the manifold 206. Thus, in various implementations, the heating chambers 202-1 and 202-2 are arranged in parallel.

A temperature sensor 604-1 may be positioned within port 408 of the enclosure 302-1 to sense a temperature of the water as it exits the heating chamber 202-1. In various implementations, the temperature sensor 604-1 may be positioned within the enclosure 302-1 to sense a temperature of the water before it exits the heating chamber 202-1 or between the enclosure 302-1 and the manifold 206 to sense a temperature of the water after it exits the heating chamber 202-1 but before it enters the manifold 206. Similarly, a temperature sensor 604-2 may be positioned within port 408 of the enclosure 302-2 to sense a temperature of the water as it exits the heating chamber 202-2. In various implementations, the temperature sensor 604-2 may be positioned within the enclosure 302-1 to sense a temperature of the water before it exits the heating chamber 202-2 or between the enclosure 302-2 and the manifold 206 to sense a temperature of the water after it exits the heating chamber 202-2 but before it enters the manifold 206. The heated water may mix in the manifold 206 and exit the water heater unit 100 at a uniform temperature via outlet 104.

A temperature sensor 606 may be positioned between manifold 206 and outlet 104 to detect a temperature of the water before it exits outlet 104. In various implementations, the temperature sensor 606 may be positioned at the manifold 206 to detect a temperature of water in the manifold 206. In some examples, the temperature sensor 606 may be positioned at outlet 104 to detect a temperature of water at outlet 104. In various implementations, the temperature sensors 604 (for example, the temperature sensors 604-1 and/or 604-2) and/or the temperature sensor 606 include one or more thermocouples, thermistors, resistance temperature detectors, semiconductor digital temperature sensors, and/or integrated circuit sensors.

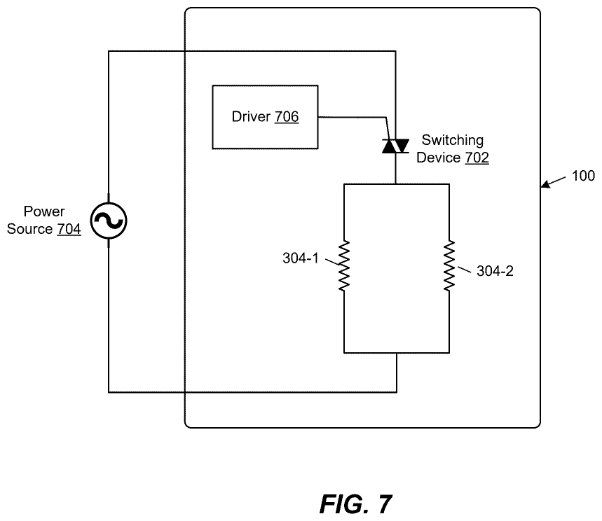

FIG. 7 is a schematic illustration of an example electric tankless water heater unit 100. For example, the water heater unit 100 of FIGS. 1, 2, and 6 may be implemented according to the principles described with reference to FIG. 7. As illustrated in the example of FIG. 7, the heating elements 304, such as the heating element 304-1 and the heating element 304-2, may be electrically connected in parallel. In various implementations, the switching device 702, the array of heating elements 304, and the power source 704 are electrically connected in series. In some examples, the switching device 702 is driven by a driver 706. In various implementations, the switching device 702 includes a solid-state switching device, a triac, a thyristor, a solid-state relay, and/or a contactor. In various implementations, the power source 704 is an external alternating current (AC) power source. For example, the power source 704 may be a 120-volt external AC power source or a 240-volt external AC power source.

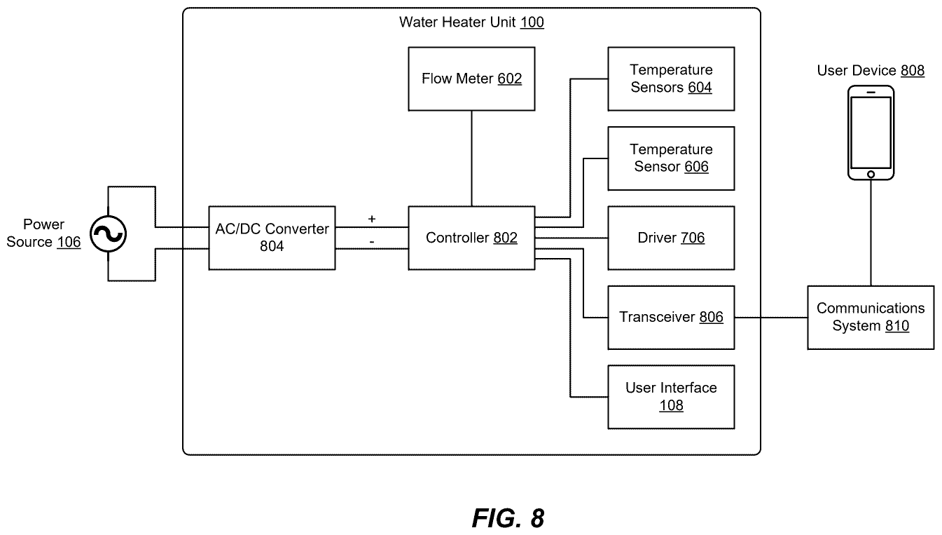

FIG. 8 is a block diagram showing an example of an interconnected hardware control system for the water heater unit 100. For example, the water heater unit 100 of FIGS. 1, 2, 6, and 7 may be implemented according to the principles described with reference to FIG. 8. As illustrated in the example of FIG. 8, the water heater unit 100 may include a controller 802. In various implementations, the controller 802 includes one or more electronic processors and non-transitory computer-readable storage media containing instructions executable by the one or more electronic processors to perform the various processes, methods, and techniques described in this specification. The controller 802 may be electrically connected to an AC to direct current (DC) converter 804. The AC/DC converter 804 may be electrically connected to the power source 704 and convert AC power from the power source 704 into DC power for the controller 802.

The controller 802 may be operatively coupled to and communicate with the user interface 108, the flow meter 602, the temperature sensors 604 (such as, for example, the temperature sensor 604-1 and/or the temperature sensor 604-2), the temperature sensor 606, the driver 706, and a transceiver 806. In various implementations, the user interface 108 includes one or more display panels, control buttons, and/or status indicators. The display panel may include a digital display showing a setpoint temperature, a current water temperature, a flow rate, and/or other operational parameters of the water heater unit 100. In various implementations, the display panel shows various alerts generated by the controller 802 (such as, for example, an indication of scale buildup).

The control buttons may include one or more temperature adjustment buttons that allow a user to increase or decrease the setpoint temperature, a power button that allows the user to turn the water heater unit 100 on or off, and/or a mode selection button that allows the user to toggle between different heating modes (such as an energy-saving mode, a normal mode, and a boost mode). The status indicators may include one or more operational status lights that indicate whether the heater is actively heating or is in a standby mode and/or one or more operational status lights that alert users to specific issues, such as scale buildup, overheating, or a need for maintenance.

In various implementations, the controller 802 controls the driver 706 to drive the heating elements 304. For example, the controller 802 may control the driver 706 to drive the heating elements 304 so that the water heater unit 100 outputs hot water from the outlet 104 at the setpoint temperature. When the controller 802 receives a signal from the flow meter 602 indicating that water is flowing through the water heater unit 100, the controller 802 may communicate with the driver 706 and command the driver 706 to close the electrical power circuit (for example, the circuit illustrated in FIG. 7), which provides electrical power to the heating elements 304. Since the flow rate of water through the water heater unit 100 may be variable, the controller 802 may command the driver 706 to modulate the power provided to the heating elements 304 so that the temperature signal from the temperature sensor 606 is maintained at the setpoint temperature (indicating that the temperature of the water delivered through the outlet 104 is at the setpoint temperature). For example, the controller 802 implements a feedback loop, which compares the temperature indicated by the sensor signal from the temperature sensor 606 with the setpoint temperature. The controller 802 may control the driver 706 to adjust or modulate the power supplied to the heating element 304 until the temperature sensed at the temperature sensor 606 reaches the setpoint temperature.

The controller 802 may also monitor sensor signals from a temperature sensor 604 to determine whether scale buildup has formed on a heating element 304. For heating chambers 202 arranged in a parallel array (such as the heating chamber 202-1 and the heating chamber 202-2), when scale begins to build up on one of the heating elements, the scale buildup may enter into a positive-feedback loop that progressively increases the scale buildup within that chamber (and no scale or less scale may form in the other chamber or chambers of the array). For example, scale may build up on the heating element 304-1 of the heating chamber 202-1. This scale buildup may reduce the cross-sectional area of the flow passage 502 of the heating chamber 202-1, which may restrict or reduce the water flow rate through the heating chamber 202-1. Since the heating chambers 202-1 and 202-2 are hydraulically connected in parallel, water will preferentially flow through the heating chamber 202-2, which may have no or less scale buildup. This reduced flow rate through the heating chamber 202-1 having the scale buildup may result in an even faster buildup of the scale within that chamber, while the increased flow rate through the heating chamber 202-2 may slow the rate of scale building up in that chamber.

Since the scale buildup may reduce the cross-sectional area (and therefore also the volume) of the flow passage 502 of the heating chamber 202-1 with the increased scale buildup relative to that of the flow passage 502 of the heating chamber 202-2 without the increased scale buildup, a relatively lower volume of water may flow through the heating chamber 202-1 than the heating chamber 202-2. As the heating elements 304 may be arranged electrically in parallel, each heating element 304 may convert an equal rate of electrical power to heat energy. Thus, during a demand draw, the temperature of the water within the heating chamber 202-1 may be relatively higher than within the heating chamber 202-2.

The controller 802 may monitor sensor signals from the temperature sensors 604-1 and 604-2 (which may be indicative of the water temperatures within the heating chambers 202-1 and 202-2, respectively) to determine whether a buildup of scale in one of the heating chambers is indicated. For example, controller 802 may monitor the sensor signals from the temperature sensors 604-1 and 604-2 to determine a differential between the temperatures in the heating chambers 202-1 and 202-2 during a hot water demand draw and determine that the buildup of scale in one of the heating chambers (for example, the heating chamber having the higher temperature) is indicated in response to the differential exceeding a threshold.

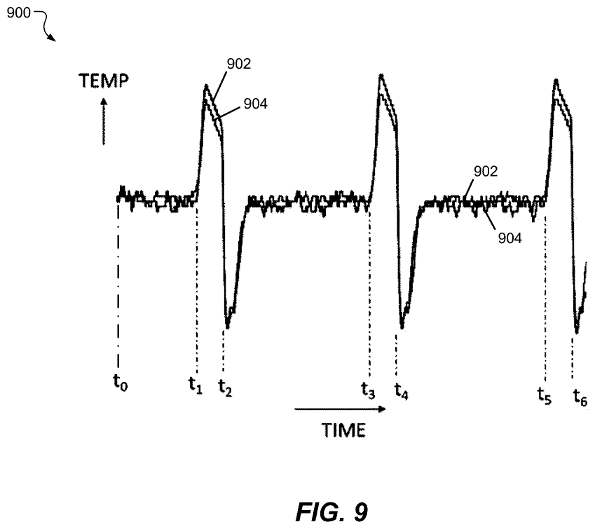

FIG. 9 is a chart 900 showing exemplary temperature readings from the temperature sensor 604-1 and the temperature sensor 604-2 over a series of three successive water draws. Chart 900 shows an example of temperature readings in heating chambers 202-1 and 202-2 in an exemplary scenario where scale buildup is not indicated. In chart 900, the horizontal independent axis shows time, and the vertical dependent axis shows temperature. Accordingly, the line 902 shows the temperature T₁ within the heating chamber 202-1 as a function of time, and line 904 shows the temperature T₂ within the heating chamber 202-2 as a function of time. As illustrated in chart 900, the first of three hot water demand draws is in progress at a time t₀. Between time t₀ and t₁ (e.g., during the first demand draw), the controller 802 receives a sensor signal from the flow meter 602 indicating that water is flowing within the water heater unit 100 and regulates the driver 706 to modulate the flow of electrical power through the heating elements 304-1 and 304-2 to maintain an outlet temperature Tout (for example, as sensed by the temperature sensor 606) at approximately the setpoint temperature (for example, a temperature in a range of between about 100° F. and about 140° F., such as about 120° F.).

As illustrated in chart 900, the temperature T₁ within the heating chamber 202-1 (indicated by line 902) and the temperature T₂ within the heating chamber 202-2 (indicated by line 904) are approximately equal, which may indicate no scale buildup in the heating chambers 202-1 and/or 202-2. Since the outlet temperature Tₒᵤₜ is the result of the water flow from the heating chamber 202-1 and the water flow from the heating chamber 202-2 mixing in the manifold 206, and the chambers 202-1 and 202-2 provide generally similar resistance to flow, the temperatures T₁ and T₂ may be approximately equal. At time t₁, the demand draw stops, and the controller 802 receives a sensor signal from the flow meter 602 indicating that water is not flowing within the heater unit 100. The controller 802 commands the driver 706 to stop providing electrical power to heating elements 304-1 and 304-2 (for example, by opening the switching device 702). Because there is latency in the system between when the demand draw stops and when electrical power to the heating elements 304-1 and 304-2 is stopped and/or because the volume of the heating chambers 202 is relatively small, the temperatures of the stagnant water in the heating chambers 202-1 and 202-2 may experience a brief (but rapid) heating to an elevated temperature, which then slowly decreases from heat loss to the external environment (illustrated in the chart 900 by the lines 902 and 904 between time t₁ and t₂).

At time t₂, the next demand draw for hot water begins. The controller 802 receives a sensor signal from the flow meter 602, indicating water is flowing through the water heater unit 100, and commands the driver 706 to provide electrical power to the heating elements 304-1 and 304-2. During the demand draw (e.g., between time t₂ and time t₃), the temperature T₁ in the heating chamber 202-1 and the temperature T₂ in the heating chamber 202-2 initially decrease (e.g., due to latency in the system) before stabilizing. Since the temperatures T₁ and T₂ stabilize to approximately the same value, they do not indicate scale buildup in the heating chambers 202-1 and/or 202-2. At time t₃, the demand draw stops, and the controller 802 receives a sensor signal from the flow meter 602, indicating water is not flowing through the water heater unit 100. In response, the controller 802 commands the driver 706 to stop providing electrical power to the heating elements 304-1 and 304-2. As a result of latency in the system and/or the relatively small volume of the heating chambers 202-1 and 202-2, the temperatures in the heating chambers rise rapidly and then slowly decrease (e.g., between time t₃ and time t₄).

At time t₄, the next demand draw for hot water begins. The controller 802 receives a sensor signal from the flow meter 602, indicating water is flowing through the water heater unit 100, and commands the driver 706 to provide electrical power to the heating elements 304-1 and 304-2. During the demand draw (e.g., between time t₄ and time t₅), the temperature T₁ in the heating chamber 202-1 and the temperature T₂ in the heating chamber 202-2 initially decrease (e.g., due to latency in the system) before stabilizing. Since the temperatures T₁ and T₂ stabilize to approximately the same value, they do not indicate scale buildup in the heating chambers 202-1 and/or 202-2. At time t₅, the demand draw stops, and the controller 802 receives a sensor signal from the flow meter 602, indicating water is not flowing through the water heater unit 100. In response, the controller 802 commands the driver 706 to stop providing electrical power to the heating elements 304-1 and 304-2. As a result of latency in the system and/or the relatively small volume of the heating chambers 202-1 and 202-2, the temperatures in the heating chambers rise rapidly and then slowly decrease (e.g., between time t₅ and time t₆).

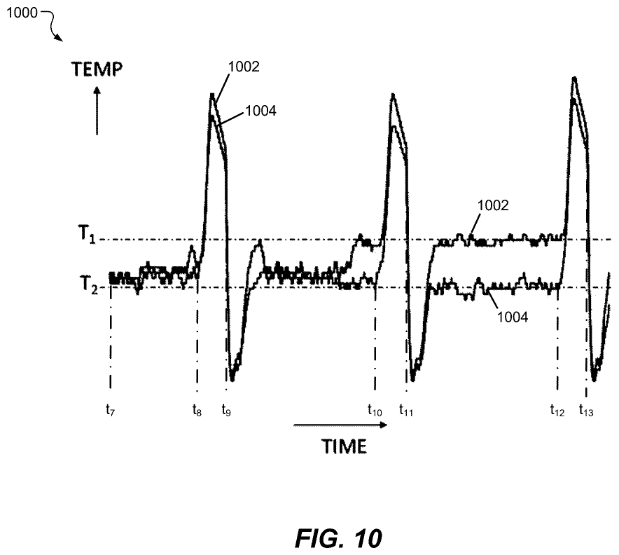

FIG. 10 is a chart 1000 showing exemplary temperature readings from the temperature sensor 604-1 and the temperature sensor 604-2 over a series of three successive water draws. Chart 1000 shows an example of temperature readings in the heating chamber 202-1 and the heating chamber 202-2 in an exemplary scenario where scale buildup is indicated. In chart 1000, the horizontal independent axis shows time, and the vertical dependent axis shows temperature. Accordingly, the line 1002 shows the temperature T₁ within the heating chamber 202-1 as a function of time, and the line 1004 shows the temperature T₂ within the heating chamber 202-2 as a function of time. As previously described, the controller 802 may monitor the temperature T₁ in the heating chamber 202-1 (as indicated by the temperature sensor 604-1) and the temperature T₂ in the heating chamber 202-2 (as indicated by the temperature sensor 604-2), and compute a differential between the temperatures T₁ and T₂ during a hot water demand draw. The controller 802 may determine an indication of scale buildup in response to the differential exceeding a threshold.

As illustrated in chart 1000, the first of three hot water demand draws is in progress at a time t₇. Between time t₇ and t₈, controller 802 receives a sensor signal from the flow meter 602 indicating that water is flowing within the heater unit 100 and regulates the driver 706 to modulate the flow of electrical power through heating elements 304-1 and 304-2 to maintain an outlet temperature Tₒᵤₜ (for example, as sensed by the temperature sensor 606) at approximately the setpoint temperature. Between time t₇ and t₈, the temperature T₁ within the heating chamber 202-1 (as indicated by the temperature sensor 604-1) and the temperature T₂ within the heating chamber 202-2 (as indicated by the temperature sensor 604-2) are approximately equal, which may not indicate scale buildup in the heating chambers 202-1 and/or 202-2. At time t₈, the demand draw stops, and the controller 802 receives a sensor signal from the flow meter 602 indicating that water is not flowing within the heater unit 100. Controller 802 commands driver 706 to stop providing electrical power to heating elements 304-1 and 304-2. Between times t₈ and t₉, the temperatures T₁ and T₂ within the heating chambers 202-1 and 202-2 rise rapidly and then slowly decrease (e.g., as a result of latency in the system and/or the relatively small volume of the heating chambers).

At time t₉, the next hot water demand draw begins. The controller 802 receives a sensor signal from the flow meter 602, indicating water is flowing through the water heater unit 100, and commands the driver 706 to provide electrical power to the heating elements 304-1 and 304-2. During the demand draw (e.g., between time t₉ and time t₁₀), the temperatures T₁ and T₂ initially decrease (e.g., due to latency in the system) before stabilizing. During the demand draw between time t₉ and time t₁₀, the differential between the temperatures T₁ and T₂ exceed a threshold, and the controller 802 determines an indication of scale buildup. In various implementations, the controller 802 determines an indication of scale buildup in the heating chamber 202 having the highest temperature (e.g., heating chamber 202-1 in the example of chart 1000). At time t₁₀, the demand draw for hot water ends. The controller 802 receives a sensor signal from the flow meter 602 indicating water is not flowing through heater unit 100. In response, the controller 802 commands the driver 706 to stop providing electrical power to the heating elements 304-1 and 304-2. As a result of latency in the system and/or the relatively small volume of the heating chambers 202-1 and 202-2, the temperatures T₁ and T₂ in the heating chambers rise rapidly and then slowly decrease (e.g., between time t₁₀ and time t₁₁).

At time t₁₁, the next hot water demand draw begins. The controller 802 receives a sensor signal from the flow meter 602, indicating water is flowing through the water heater unit 100, and commands the driver 706 to provide electrical power to the heating elements 304-1 and 304-2. During the demand draw (e.g., between time t₁₁ and time t₁₂), the temperatures T₁ and T₂ initially decrease (e.g., due to latency in the system) before stabilizing. During the demand draw between time t₁₁ and time t₁₂, the differential between the temperatures T₁ and T₂ again exceed a threshold, and the controller 802 again determines an indication of scale buildup. In various implementations, the controller 802 determines an indication of scale buildup in the heating chamber 202 having the highest temperature (e.g., heating chamber 202-1 in the example of chart 1000). At time t₁₂, the demand draw for hot water ends. The controller 802 receives a sensor signal from the flow meter 602 indicating water is not flowing through heater unit 100. In response, the controller 802 commands the driver 706 to stop providing electrical power to the heating elements 304-1 and 304-2. As a result of latency in the system and/or the relatively small volume of the heating chambers 202-1 and 202-2, the temperatures in the heating chambers rise rapidly and then slowly decrease (e.g., between time t₁₂ and time t₁₃).

In various implementations, the controller 802 averages the temperature differential over a period of time (for example, 5, 10, 15, 20, 25, 30 seconds, etc.) and determines an indication of scale buildup in response to the average temperature differential over the period of time exceeding the threshold. Averaging the temperature differential over the period of time may help the controller 802 avoid erroneous nuisance indications caused by intermittent temperature fluctuations (for example, caused by spurious temperature sensor 604 readings). In some examples, the controller 802 requires the temperature differential to be met or exceeded a predetermined number of times, with a stoppage of water flow between each occurrence, before determining the indication of scale buildup.

In response to determining the indication of scale buildup, the controller 802 can generate and output an alert or error message. For example, the controller 802 can generate a message rendered on the display panel of the user interface 108, which alerts users that scale buildup is indicated. In various implementations, the controller 802 can illuminate a status indicator of the user interface 108, alerting users that scale buildup is indicated. Returning to FIG. 8, in various implementations, the water heater unit 100 includes a transceiver 806 for sending and/or receiving data over a communications system 810. In some examples, the controller 802 communicates with a user device 808 via the transceiver 806 and the communications system 810.

In various implementations, the communications system 810 includes one or more networks, such as a General Packet Radio Service (GPRS) network, a Time-Division Multiple Access (TDMA) network, a Code-Division Multiple Access (CDMA) network, a Global System of Mobile Communications (GSM) network, an Enhanced Data Rates for GSM Evolution (EDGE) network, a High-Speed Packet Access (HSPA) network, an Evolved High-Speed Packet Access (HSPA+) network, a Long Term Evolution (LTE) network, a Worldwide Interoperability for Microwave Access (WiMAX) network, a 5th-generation mobile network (5G), an Internet Protocol (IP) network, a Wireless Application Protocol (WAP) network, or an IEEE 802.11 standards network, as well as any suitable combination of the above networks. In various implementations, the communications system 810 includes an optical network, a local area network, and/or a global communication network, such as the Internet.

In some examples, the user device 808 may include a personal computer (e.g., a desktop computer and/or a laptop computer), a server (e.g., a dedicated server and/or a virtual, cloud-based server), a mobile device (e.g., a smartphone and/or tablet), a workstation, a single-board computer (e.g., an Arduino and/or Raspberry Pi computer), a virtual reality headset, and/or an augmented reality device. In various implementations, the controller 802 transmits a signal representing the indication of the scale buildup to the user device 808 (for example, via the transceiver 806 and the communications system 810). The user device 808 may alert a user that scale buildup may have occurred in one of the heating chambers 202 (such as the heating chamber 202-1 in the example of chart 1000).

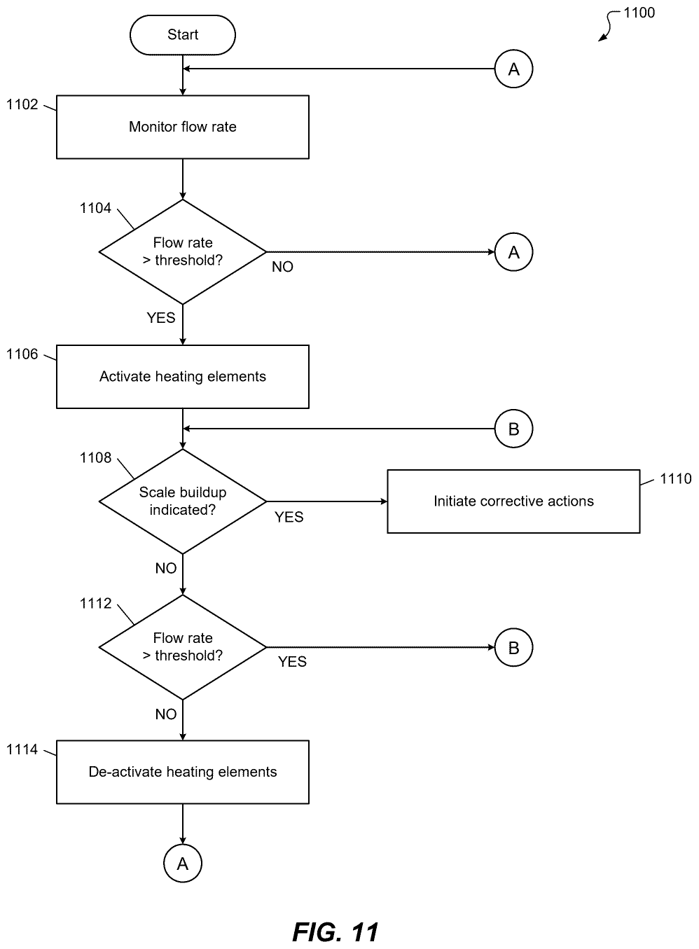

FIG. 11 is a flowchart of an example process 1100 for controlling the water heater unit 100. In the example process 1100, the controller 802 monitors sensor signals from the flow meter 602 (at block 1102). In various implementations, the controller 802 continuously monitors the sensor signals. For example, the controller 802 monitors the sensor signals at regular intervals. The controller 802 may determine a flow rate (e.g., of water flowing between the inlet 102 and the manifold 204) based on the sensor signals. In the example process 1100, the controller 802 determines whether the flow rate exceeds a threshold (at decision block 1104). The flow rate exceeding the threshold may indicate that water is flowing through the water heater unit 100 in response to a demand draw for hot water. Conversely, the flow rate not exceeding the threshold may indicate the absence of a draw demand. By way of example, the threshold may be set to a level that distinguishes between demands for hot water and small leaks in the downstream plumbing system. In response to the controller 802 determining that the water flow rate does not exceed the threshold (“NO” at decision block 1104), the controller 802 continues monitoring the flow meter signal at block 1102.

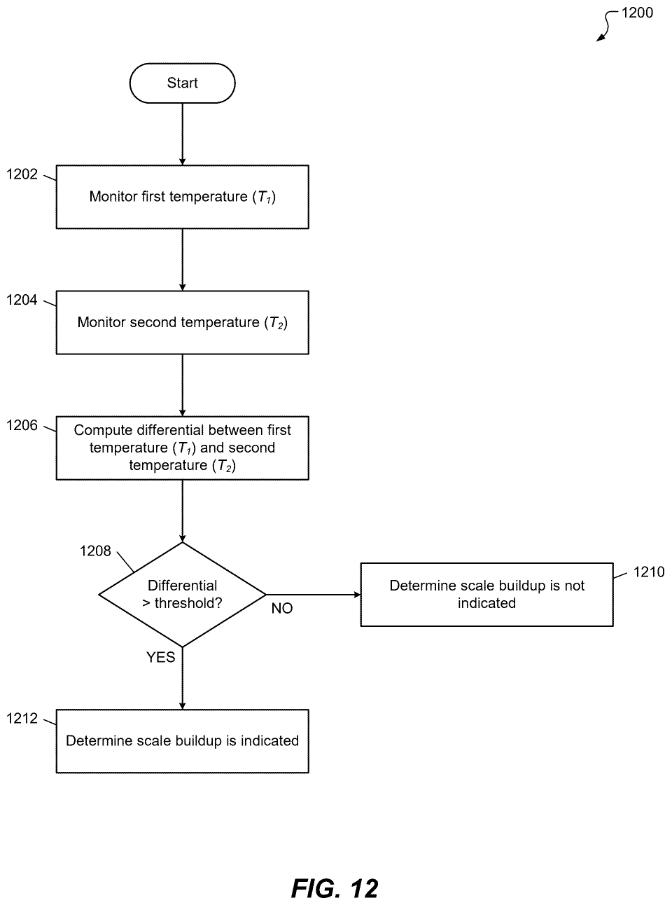

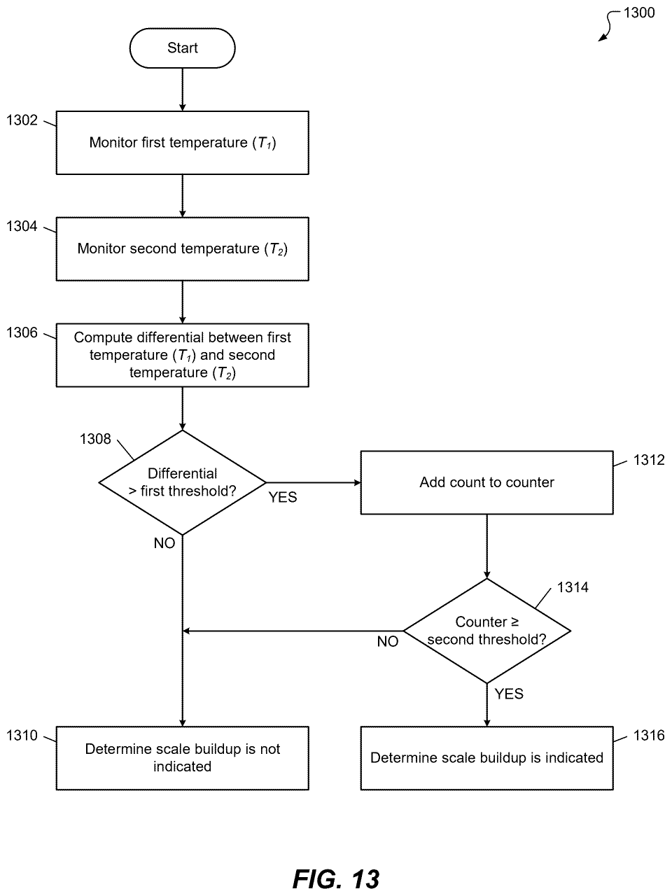

In response to the controller 802 determining that the water flow rate exceeds the threshold (“YES” at decision block 1104), the controller 802 activates the heating elements 304 (at block 1106). In various implementations, the controller 802 commands the driver 706 to adjust or modulate the heating elements 304 to maintain the temperature sensed by the temperature sensor 606 at the setpoint temperature. In the example process 1100, the controller 802 determines whether scale buildup is indicated (at decision block 1108). For example, as previously described, the controller 802 monitors the temperature sensors 604 and determines a temperature differential between the temperatures in the heating chambers 202. The controller 802 may determine that scale buildup is indicated in response to the temperature differential exceeding a threshold and determine that scale buildup is not indicated in response to the temperature differential not exceeding the threshold. In various implementations, the controller 802 may determine that scale buildup is indicated or is not indicated according to any of the previously described techniques and/or any of the techniques described with reference to FIGS. 12 and 13.

In response to the controller 802 determining that scale buildup is indicated (“YES” at decision block 1108), the controller 802 initiates corrective actions (at block 1110). In various implementations, the corrective actions include alerting the user that scale buildup is indicated via the user interface 108 and/or transmitting the signal that scale buildup is indicated to the user device 808 (for example, according to any of the previously described techniques). The corrective actions may additionally include the controller 802 commanding the driver 706 not to allow current flow through the heating elements 304 until the water heater unit 100 has been serviced. In response to the controller 802 not determining that scale buildup is indicated (“NO” at decision block 1108), the controller 802 determines whether the flow rate indicated by the flow meter 602 exceeds the threshold at decision block 1112. The flow rate exceeding the threshold may indicate that water is still flowing through the water heater unit 100 and that the demand draw for hot water is ongoing. Conversely, the flow rate not exceeding the threshold may indicate that the demand draw for hot water has stopped. In response to determining that the flow rate exceeds the threshold (“YES” at decision block 1112), the controller 802 again determines whether scale buildup is indicated at decision block 1108. In response to determining that the flow rate does not exceed the threshold (“NO” at decision block 1112), the controller 802 deactivates the heating elements 304 at block 1114, and the controller 802 continues monitoring the flow meter signal at block 1102. For example, the controller 802 commands the driver 706 to open the switching device 702 to stop providing electric power to the heating elements 304.

FIG. 12 is a flowchart of an example process 1200 for determining whether scale buildup in a water heater unit 100 is indicated. In the example process 1200, the controller 802 monitors a sensor signal from the temperature sensor 604-1 (at block 1202). The controller 802 may determine a temperature T₁ of water in the heating chamber 202-1 based on the sensor signal. In the example process 1200, the controller 802 monitors a sensor signal from the temperature sensor 604-2 (at block 1204). The controller 802 may determine a temperature T₂ of water in the heating chamber 202-2 based on the sensor signal. In the example process 1200, the controller 802 computes a differential between the temperature T₁ of water in the heating chamber 202-1 and the temperature T₂ of water in the heating chamber 202-2 (at block 1206). In various implementations, the controller 802 computes the differential between an average of the temperature T₁ over a period of time and an average of the temperature T₂ over the same period of time. In some examples, the period of time may be about 5, 10, 15, 20, 25, 30 seconds, etc.

In the example process 1200, the controller 802 determines whether the differential computed at block 1206 exceeds a threshold (at decision block 1208). As previously described, the differential exceeding the threshold during a demand draw may be indicative of scale buildup in a heating chamber 202. In response to determining that the differential does not exceed the threshold (“NO” at decision block 1208), the controller 802 determines that scale buildup is not indicated at block 1210. Optionally, in some examples, the process continues monitoring the sensor signals from the temperature sensors 604-1 and 604-2 (at blocks 1202 and 1204 respectively). In response to determining that the differential exceeds the threshold (“YES” at decision block 1208), the controller 802 determines that scale buildup is indicated at block 1212. Optionally, in some examples, the process continues monitoring the sensor signals from the temperature sensors 604-1 and 604-2 (at blocks 1202 and 1204 respectively).

FIG. 13 is a flowchart of an example process 1300 for determining whether scale buildup in a water heater unit 100 is indicated. In the example process 1300, the controller 802 monitors a sensor signal from the temperature sensor 604-1 (at block 1302). The controller 802 may determine a temperature T₁ of water in the heating chamber 202-1 based on the sensor signal. In the example process 1300, the controller 802 monitors a sensor signal from the temperature sensor 604-2 (at block 1304). The controller 802 may determine a temperature T₂ of water in the heating chamber 202-2 based on the sensor signal. In the example process 1300, the controller 802 computes a differential between the temperature T₁ of water in the heating chamber 202-1 and the temperature T₂ of water in the heating chamber 202-2 (at block 1306). In various implementations, the controller 802 computes the differential between an average of the temperature T₁ over a period of time and an average of the temperature T₂ over the same period of time. In some examples, the period of time may be about 5, 10, 15, 20, 25, 30 seconds, etc.

In the example process 1300, the controller 802 determines whether the differential computed at block 1306 exceeds a threshold (at decision block 1308). As previously described, the differential exceeding the threshold during a demand draw may be indicative of scale building in a heating chamber 202. In response to determining that the differential does not exceed the threshold (“NO” at decision block 1308), the controller 802 determines that scale buildup is not indicated at block 1310. In response to determining that the differential exceeds the threshold (“YES” at decision block 1308), the controller 802 adds a count to a counter at block 1312. In various implementations, the counter is reset at the beginning of each demand draw (for example, as determined at decision block 1104). In the example process 1300, the controller 802 determines whether the counter meets or exceeds a threshold (at decision block 1314). The threshold may indicate a number of times during the current demand draw that the differential computed at block 1306 exceeds the threshold at decision block 1308. In various implementations, requiring the threshold to be exceeded a certain number of times may reduce or eliminate spurious indications of scale buildup. In some examples, the threshold at decision block 1314 may be an integer value m. In various implementations, the integer value m may be any integer between about 1 and about 100. The controller 802 may determine that scale buildup is not indicated (at block 1310) in response to the the counter not meeting or exceeding the threshold (“NO” at decision block 1314). The controller 802 may determine that scale buildup is indicated (at block 1316) in response to the counter meeting or exceeding the threshold (“YES” at decision block 1314).

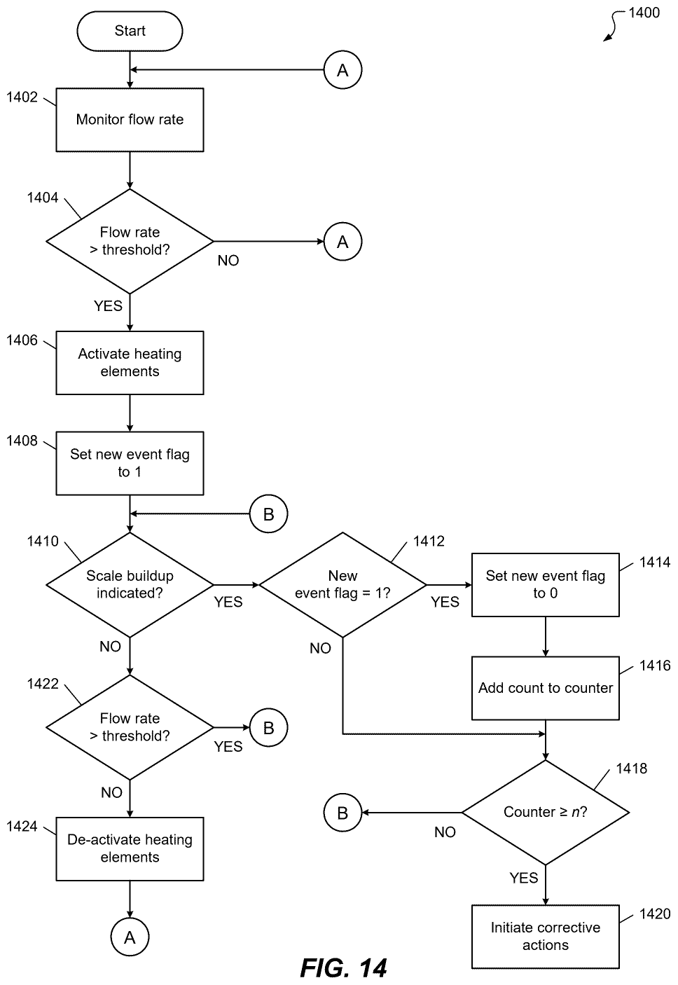

FIG. 14 is a flowchart of an example process 1400 for controlling the water heater unit 100. In the example process 1400, the controller 802 monitors sensor signals from the flow meter 602 (at block 1402). In various implementations, the controller 802 continously monitors the sensor signals. For example, the controller 802 monitors the sensor signals at regular intervals. The controller 802 may determine a flow rate (e.g., of water flowing between the inlet 102 and the manifold 204) based on the sensor signals. In the example process 1400, the controller 802 determines whether the flow rate exceeds a threshold (at decision block 1404). The flow rate exceeding the threshold may indicate that water is flowing through the water heater unit 100 in response to a demand draw for hot water. Conversely, the flow rate not exceeding the threshold may indicate the absence of a draw demand. In response to the controller 802 determining that the water flow rate does not exceed the threshold (“NO” at decision block 1404), the controller 802 continues monitoring the flow meter signal at block 1402.

In response to the controller 802 determining that the water flow rate exceeds the threshold (“YES” at decision block 1404), the controller 802 activates the heating elements 304 (at block 1406). In various implementations, the controller 802 commands the driver 706 to adjust or modulate the heating elements 304 to maintain the temperature sensed by the temperature sensor 606 at the setpoint temperature. In the example process 1400, the controller 802 initializes a marker or indicator (such as a new event flag) for tracking an occurrence of an event or condition and sets the new event flag to 1 (at block 1408). Setting the new event flag to 1 indicates that a new event has started. In various implementations, setting the new event flag to 1 indicates that a demand draw (for example, a new or distinct demand draw) has started. In the example process 1400, the controller 802 determines whether scale buildup is indicated (at decision block 1410). For example, as previously described, the controller 802 monitors the temperature sensors 604 and determines a temperature differential between the temperatures in the heating chambers 202. The controller 802 may determine that scale buildup is indicated in response to the temperature differential exceeding a threshold and determine that scale buildup is not indicated in response to the temperature differential not exceeding the threshold. In various implementations, the controller 802 may determine that scale buildup is indicated or is not indicated according to any of the previously described techniques, such as the techniques described with reference to FIGS. 12 and 13.

In response to the controller 802 determining that scale buildup is indicated (“YES” at decision block 1410), the controller 802 determines whether the new event flag is set to 1 at decision block 1412. In response to the new event flag being set to 1 (“YES” at decision block 1412), the controller 802 sets the new event flag to 0 at block 1414 and adds a count to the counter at block 1416. In various implementations, setting the new event flag to 0 at block 1414 ensures that only a single count is added to the counter at block 1416 for each distinct demand draw. Accordingly, the counter may record a number of distinct demand draws during which scale buildup were indicated. In response to the new event flag not being set to 1 (“NO” at decision block 1412), the controller 802 determines whether the counter is greater than or equal to an integer value n at decision block 1418. In response to the counter being greater than or equal to the interger value n (“YES” at decision block 1418), the controller 802 initiates corrective actions at block 1420.

In various implementations, the corrective actions that the controller 802 initiates at block 1420 may be any of the previously described corrective actions. By delaying corrective actions until scale buildup has been indicated in at least n-number of demand draw cycles, the process 1400 avoids allowing a single (potentially spurious) indication of scale buildup to cause the water heater unit 100 to shut down, prompt the end user to take corrective action, etc. In various implementations, the integer value n may be any value between about 2 and about 100. In response to the counter not being greater than or equal to the integer value n (“NO” at decision block 1418), the controller 802 continues determining whether scale builduip is indicated at decision block 1410.

In response to the controller determining that scale buildup is not indicated (“NO” at decision block 1410), the controller 802 determines whether the flow rate indicated by the flow meter 602 exceeds the threshold at decision block 1422. The flow rate exceeding the threshold may indicate that water is still flowing through the water heater unit 100 and that the demand draw for hot water is ongoing. Conversely, the flow rate not exceeding the threshold may indicate that the demand draw for hot water has stopped. In response to determining that the flow rate exceeds the threshold (“YES” at decision block 1422), the controller 802 again determines whether scale buildup is indicated at decision block 1410. In response to determining that the flow rate does not exceed the threshold (“NO” at decision block 1422), the controller 802 deactivates the heating elements at block 1424 (for example, by opening the switching device 702 to stop providing electric power to the heating elements 304) and continues monitoring the signal from the flow meter 602 at block 1402.

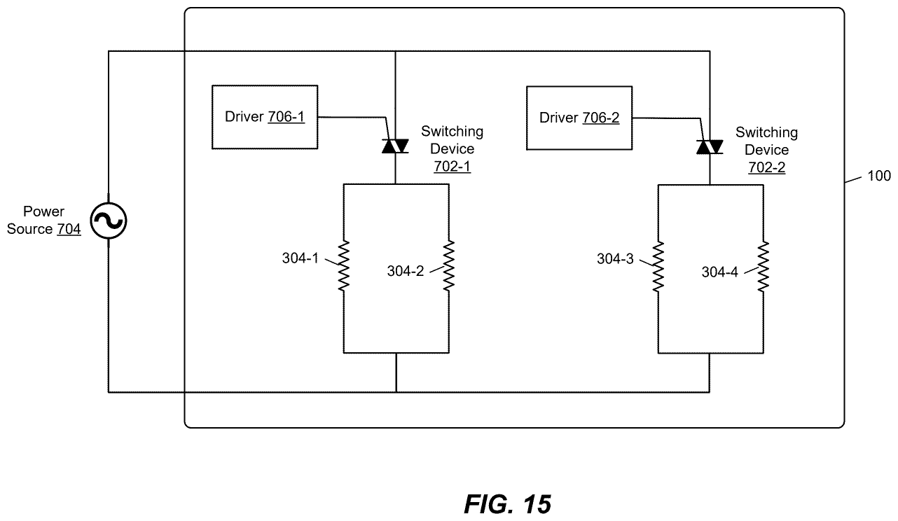

FIG. 15 is a schematic illustration of an example of the electric tankless water heater unit 100. The example of the water heater unit 100 illustrated in FIG. 15 is substantially similar to the water heater unit previously described with reference to FIGS. 1-7 except that the water heater unit 100 of FIG. 15 includes multiple arrays of heating elements 304 (and corresponding heating chambers 202) instead of a single array (as illustrated in FIGS. 1-7). In various implementations, each array includes one or more heating elements 304 electrically connected in parallel. Each array of heating elements 304 may be controlled by a switching device 702, which may be driven by a driver 706. Although two arrays of heating elements 304 are shown in the example of FIG. 15, the water heater unit 100 may include any number of arrays of heating elements 304. Similarly, although FIG. 15 illustrates each array as having two heating elements 304, each array may consist of any number of heating elements 304. In various implementations, the arrays (along with their corresponding switching devices 702) are electrically connected in parallel. Each array may be electrically connected in series with its respective switching device 702 and the power source 704.

For example, as illustrated in the example of FIG. 15, the water heater unit 100 may include a first array, which consists of the heating elements 304-1 and 304-2, and a second array, which consists of the heating elements 304-3 and 304-4. The heating elements 304-1 and 304-2 may be electrically connected in parallel in the first array, and the first array may be electrically connected in series with the switching device 702-1 and the power source 704. Thus, the driver 706-1 may control the heating elements 304-1 and 304-2 by driving the switching device 702-1. Similarly, the heating elements 304-3 and 304-4 may be electrically connected in parallel in the second array, and the second array may be electrically connected in series with the switching device 702-2 and the power source 704. Thus, the driver 706-2 may control the heating elements 304-3 and 304-4 by driving the switching device 702-2.

As previously described, each of the heating elements 304-1-304-4 may be disposed within a respective heating chamber 202, and a temperature sensor 604 may be disposed within a port 408 of an enclosure 302 of the heating chamber 202. The controller 802 may monitor sensor signals from each temperature sensor 604 and determine a temperature within each of the heating chambers 202 based on the sensor signals. In some scenarios, scale buildup may not be removed from a heating chamber 202 and may continue to grow until the flow passage 502 within the heating chamber 202 is substantially blocked and/or thermal bridging between the heating element 304 and the enclosure 302 occurs. This blockage and/or thermal bridging may cause the temperature within the heating chamber 202 to exceed a threshold when the heating element 304 is activated in response to a demand draw. The controller 802 can determine whether this blockage and/or thermal bridging condition has occurred by monitoring the temperatures within the heating chambers 202.

For example, the controller 802 monitors the temperatures within each of the heating chambers 202 associated with each of the heating elements 304-1-304-4 during a hot water demand draw. In response to determining that the temperature within a heating chamber 202 exceeds a high temperature threshold, the controller 802 initiates corrective actions. In at least some embodiments, the corrective actions include alerting the user that scale buildup is indicated via the user interface 108 and/or transmitting the signal that scale buildup is indicated to the user device 808 (for example, according to any of the previously described techniques). In at least some embodiments, the corrective actions include the controller 802 commanding the driver 706 associated with that heating element to open the switching device 702 associated with that heating chamber 202. This disconnects the heating elements 304 within the array that includes the blocked and/or thermally bridged heating chamber 202. In various implementations, the high temperature threshold is a temperature below the boiling point of water. Such a threshold allows the controller 802 to shut down the heating element 304 in the blocked and/or thermally bridged heating chamber 202 before water in the chamber boils. In some examples, the high temperature threshold is set to a value in a range of between about 180° F. and about 200° F.

In the example of FIG. 15, the water heater unit 100 includes multiple arrays of heating elements 304 (and heating chambers 202). Thus, the controller 802 may continue to operate the remaining arrays so that the water heater unit 100 can continue to provide hot water even after one of the switching devices 702 is disconnected. In various implementations, the controller 802 keeps the disconnected switching device 702 disconnected until heating chamber 202 with the scale buildup has been serviced. In some examples, the controller 802 resumes normal operations in response to the temperature within the heating chamber 202 dropping below a low temperature threshold. In various implementations, the low temperature threshold may be set to a value in a range of between about 140° F. and about 160° F. In various implementations, the controller 802 tracks a number of heating cycles during which the high temperature threshold has been reached and opens the switching device 702 to disconnect the array containing the blocked and/or thermally bridged heating chamber 202 in response to a predetermined number of occurrences being reached. In some examples, the number of occurrences may be any number between about one and about 100.

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more processes within any given method may be executed in a different order—or processes may be executed concurrently or in combination with each other—without altering the principles of this disclosure. Similarly, instructions stored in a non-transitory computer-readable medium may be executed in a different order—or concurrently—without altering the principles of this disclosure. Unless otherwise indicated, the numbering or other labeling of instructions or method steps is done for convenient reference and does not necessarily indicate a fixed sequencing or ordering.

It should also be noted that a plurality of hardware and software-based devices, as well as a plurality of different structural components may be utilized in various implementations. Aspects, features, and instances may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one instance, the electronic based aspects of the invention may be implemented in software (for example, stored on non-transitory computer-readable medium) executable by one or more processors. As a consequence, it should be noted that a plurality of hardware and software-based devices, as well as a plurality of different structural components may be utilized to implement the invention. For example, “control units” and “controllers” described in the specification can include one or more electronic processors, one or more memories including a non-transitory computer-readable medium, one or more input/output interfaces, and various connections (for example, a system bus) connecting the components.

Unless the context of their usage unambiguously indicates otherwise, the articles “a,” “an,” and “the” should not be interpreted to mean “only one.” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable connections or links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations collectively. To reiterate, those electronic processors and processing may be distributed.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. The direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element. Furthermore, while the figures illustrate a number of components and/or steps, any one or more of the components and/or steps may be omitted or duplicated, as suitable for the application and setting.

Additionally, operations (such as processes, decisions, inputs, outputs, actions, messages, interactions, events, and/or any other operations) shown in the flowcharts and/or message sequence charts may be illustrated once each and in a particular order in the drawings. However, in various implementations, the operations may be reordered and/or repeated as may be suitable. In some examples, different operations may be performed in parallel, as may be appropriate.

The term computer-readable medium does not encompass transitory electrical or electromagnetic signals or electromagnetic signals propagating through a medium—such as on an electromagnetic carrier wave. The term “computer-readable medium” is considered tangible and non-transitory. The functional blocks, flowchart elements, and message sequence charts described above serve as software specifications that can be translated into computer programs by the routine work of a skilled technician or programmer.

What is claimed is:

1. A water heating system comprising:
a first heating chamber arranged in parallel with a second heating chamber;
a first temperature sensor positioned to sense a first temperature in the first heating chamber;
a second temperature sensor positioned to sense a second temperature in the second heating chamber; and
a controller configured to:
determine a first temperature value based on a first sensor signal from the first temperature sensor,
determine a second temperature value based on a second sensor signal from the second temperature sensor,
compute a differential between the first temperature value and the second temperature value;
in response to the differential exceeding a first threshold, determine that scale buildup is indicated; and
in response to determining that scale buildup is indicated, initiate a corrective action.

2. The system of claim 1, wherein:
the first temperature value represents an average of the first sensor signal taken over time; and
the second temperature value represents an average of the second sensor signal taken over time.

3. The system of claim 1, wherein the controller is further configured to:
determine a number of times the differential exceeds the threshold; and
determine that scale buildup is indicated in response to the number of times exceeding a second threshold.

4. The system of claim 1, wherein the controller is configured to:
determine a number of hot water demand draws during which the differential exceeds a second threshold;
wherein the corrective action is only initiated when the number of hot water demand draws exceeds the second threshold.

5. The system of claim 1, wherein the controller is further configured to:
determine a number of hot water demand draws during which the differential exceeds a second threshold;
wherein the corrective action is only initiated when the number of hot water demand draws exceeds the second threshold.

6. The system of claim 1, wherein the first sensor signal and the second sensor signal are generated during a hot water demand draw.

7. The system of claim 1, wherein the controller is configured to determine that scale buildup is indicated in one of the first heating chamber and the second heating chamber.

8. The system of claim 1, further comprising:
a heating element disposed in the first heating chamber;
wherein the controller is further configured to deactivate the heating element in response to the first temperature exceeding a second threshold.

9. The system of claim 1, further comprising:
a user interface;
wherein the corrective action comprises displaying on the user interface an indication that scale buildup has occurred.

10. The system of claim 1, further comprising:
a transceiver configured to communicate with a user device;
wherein the corrective action comprises transmitting, to the user device via the transceiver, an indication that scale buildup has occurred.

11. A method for controlling a water heating system, comprising:
determining a first temperature value based on a first sensor signal from a first temperature sensor, the first temperature sensor positioned to send a temperature in a first heating chamber;
determining a second temperature value based on a second sensor signal from a second temperature sensor, the second temperature sensor positioned to sense a second temperature in a second heating chamber, the second heating chamber being arranged in parallel with the first heating chamber;
computing a differential between the first temperature value and the second temperature value;
in response to the differential exceeding a first threshold, determining that scale buildup is indicated; and
in response to determining that scale buildup is indicated, initiating a corrective action.

12. The method of claim 11, wherein:
the first temperature value represents an average of the first sensor signal taken over time; and
the second temperature value represents an average of the second sensor signal taken over time.

13. The method of claim 11, further comprising:
determining a number of times the differential exceeds the threshold; and
determining that scale buildup is indicated in response to the number of times exceeding a second threshold.

14. The method of claim 11, further comprising:
determining a number of hot water demand draws during which the differential exceeds a second threshold; and
determining that scale buildup is indicated in response to the number of hot water demand draws exceeding the second threshold.

15. The method of claim 11, further comprising:
determining a number of hot water demand draws during which the differential exceeds a second threshold;
wherein the corrective action is only initiated when the number of hot water demand draws exceeds the second threshold.

16. The method of claim 11, wherein the first sensor signal and the second sensor signal are generated during a hot water demand draw.

17. The method of claim 11, further comprising determining that scale buildup is indicated in one of the first heating chamber and the second heating chamber.

18. The method of claim 11, wherein the corrective action comprises deactivating a heating element in response to the first temperature exceeding a second threshold, the heating element being disposed in the first heating chamber.

19. The method of claim 11, wherein the corrective action comprises displaying an indication that scale buildup has occurred on a user interface.

20. The method of claim 11, wherein the corrective action comprises transmitting an indication that scale buildup has occurred to a user device via a transceiver.
